(19) United States
(12) Patent Application Publication
(10) Pub. No.: US 2022/0303748 A1
(43) Pub. Date: Sep. 22, 2022

(54) IOPS FUNCTIONAL MODEL FOR MISSION CRITICAL SERVICES

(71) Applicant: Telefonaktiebolaget LM Ericsson (publ), Stockholm (SE)

(72) Inventors: John Camilo Solano Arenas, Neuss (DE); Joakim Åkesson, Landvetter (SE)

(21) Appl. No.: 17/619,798

(22) PCT Filed: Jun. 25, 2020
(86) PCT No.: PCT/EP2020/067781

§ 371 Date: Dec. 16, 2021

Related U.S. Application Data
(60) Provisional application No. 62/868,241, filed on Jun. 28, 2019.

(51) Int. Cl. H04W 4/90; H04W 48/16; H04W 60/00; H04W 76/50

(52) U.S. Cl. CPC H04W 4/90; H04W 48/16; H04W 60/00; H04W 76/50

(57) ABSTRACT

Disclosed herein is a method and a wireless device for enabling isolated operation for public safety, IOPS, mission critical, MC, operation in an IOPS system, the wireless device comprising processing circuitry configured to operatively provide an IOPS MC application plane function, wherein: an IOPS MC connectivity client is configured to operatively support a first reference point between the IOPS connectivity client and an IOPS connectivity function in the IOPS MC system, which first reference point is used for at least one of: user registration transactions and IOPS discovery procedures; and an IOPS service client is configured to operatively support a second reference point between the IOPS MC service client and an IOPS packet distribution function in the IOPS MC system, which second reference point is used to carry IP packets between the IOPS MC service client and the IOPS packet distribution function based on unicast transmissions.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Mission Critical (MC) communication services are essential for the work performed by public safety users (e.g., police and fire brigade). The MC communication services require preferential handling (e.g., prioritized MC calls for emergency and imminent threats) compared to normal telecommunication services. Furthermore, the MC communication services require several resilience features capable of providing a guaranteed service level even in the event of network and/or backhaul infrastructure failures.

The most commonly used communication method for public safety users is Group Communication (GC), which delivers the same information to multiple users. One type of GC is known as Push to Talk (PTT) service. A GC system may be designed with a centralized architecture approach, in which a centralized GC control node provides full control of all group data (e.g., group membership, policies, user authorities and prioritizations). Such approach relies heavily on availability of a network infrastructure. This type of operation is also known as Trunked Mode Operation (TMO) or on-network operation.

3GPP-based networks that support the GC services or the MC services like Mission Critical Push-To-Talk (MCPTT) are defined in 3GPP TS 23.280 v16.3.0 and 3GPP TS 23.379 v16.3.0. Other MC services like Mission Critical Video (MCVideo) and Mission Critical Data (MCData) are specified in 3GPP TS 23.281 v16.3.0 and 3GPP TS 23.282 v16.3.0, respectively.

Each of the MC services may support several types of communications (e.g., group call, private call) among users. There are several common functions and entities (e.g., group, configuration, identity) that are used by the MC services. The common functional architecture, as described in 3GPP TS 23.280 v16.3.0, for supporting the MC services includes a central MC service server connected to the network that provides full control of the MC service data and an MC service client(s) operating on a user-equipment (UE) that provides MC service communications support. The MC service UE primarily obtains access to a MC service via E-UTRAN using the evolved packet system (EPS) architecture as defined in 3GPP TS 23.401 v16.3.0.

If a MC service UE is going out of the network coverage, the MC service UE may attempt to switch to the off-network mode of operation to make use of proximity services (ProSe) as specified in 3GPP TS 23.303 v15.1.0. ProSe provides support to the off-network operation based on direct communication with another UE without direct support from the network. In this case, the MC service clients operating on the UEs are controlling and providing the MC service communication. In this regard, all the configuration data, which is similar to but normally a subset of the configuration data for an on-network operation, must be pre-provisioned in each UE.

In a 3GPP based network that provides the MC services, the MC service may be guaranteed even in the case of backhaul failure by using Isolated E-UTRAN Operations for Public Safety (IOPS) as described in 3GPP TS 23.401 v16.3.0 Annex K. The IOPS functionality provides local connectivity to the public safety users' devices that are within the communication range of E UTRAN radio base station(s) (eNB) capable of supporting IOPS, such as an IOPS-capable eNB(s). The IOPS-capable eNB(s) is co-sited with a local Evolved

Packet Core (EPC) that is used during the IOPS mode of operation. The local EPC may include such functional entities as Mobility Management Entity (MME), Serving Gateway (S-GW), Packet Data Network Gateway (P-GW), and Home Subscriber Server (HSS).

The IOPS EPS system, which includes the IOPS-capable eNB(s) and the local EPC, can be used in different types of deployments. One common deployment scenario is when radio base station is located on a remote location (e.g., an island) and connected to the macro core network via, for example, a microwave link. If there is a microwave link failure, it is critical for public safety users to be able to at least have local connectivity for the communication between the public safety users in the coverage of the IOPS-capable eNBs.

When the IOPS mode of operation is initiated, for example due to a backhaul link failure, the public safety users may be served by the IOPS EPS system. To support the MC services during the IOPS mode of operation, the IOPS MC functional model needs to be specified in 3GPP. For this matter, a 3GPP study has identified key issues and potential solutions in 3GPP TR 23.778 v16.0.0. According to 3GPP TR 23.778 v16.0.0, the IOPS MC functional model may be based on the off-network functional model as described in 3GPP TS 23.280 v16.3.0 and 3GPP TS 23.379 v16.3.0. Accordingly, some methods for wireless devices and IOPS MC systems were defined to support the MC services over an IOPS EPS.

### SUMMARY

There currently exist certain challenge(s). The MC services over IOPS EPS systems needs to be specified in 3GPP Release 17. Accordingly, an IOPS MC functional model also needs to be defined and specified. Further, it is necessary to define how to establish communication between MC UEs and IOPS EPS system based on the IOPS MC function model during an IOPS mode of operation.

Certain aspects of the present disclosure and their embodiments may provide solutions to the aforementioned or other challenges. Aspect discussed herein defines the IOPS MC application functional model to support MC services during the IOPS mode of operation in 3GPP based systems. The IOPS MC application functional model includes how the network resource management is defined for the IOPS mode of operation, for example, how to establish the communication between the MC UEs and the IOPS EPS system.

The present disclosure defines an IOPS MC application functional model to support MC service during IOPS mode of operation in a 3GPP based system(s). Also, the IOPS MC application functional model includes how the network resources between MC UEs and IOPS EPS system are configured for the IOPS mode of operation.

There are, proposed herein, various embodiments which address one or more of the issues disclosed herein.

### FIG. 1

One embodiment is directed to a method performed by a wireless device for enabling isolated operation for public safety (IOPS) mission critical (MC) operation is provided. As illustrated in FIG. 1, the method includes providing (100) an IOPS MC signaling control plane function. The IOPS MC signaling control plane function is configured to enable MC user registration to an IOPS MC system. The IOPS MC signaling control plane function is also configured to enable IOPS discovery in the IOPS MC system. The method also includes providing (102) an IOPS MC application plane function configured to provide an IPOS service function and an IOPS connectivity function.

### FIG. 2

Another embodiment is directed to a method performed by a node coupled to an IOPS EPS for implementing an IOPS MC application service is provided. As illustrated in FIG. 2, the method includes providing (200) an IOPS MC signaling control plane function. The IOPS MC signaling control plane function is configured to enable MC user registration to an IOPS MC system. The IOPS MC signaling control plane function is also configured to enable IOPS discovery in the IOPS MC system. The method also includes providing (202) an IOPS MC application plane function configured to provide an IPOS packet distribution function and an IOPS connectivity function.

A particular embodiment is directed to a method performed by a wireless device for enabling isolated operation for public safety (IOPS) mission critical (MC) operation in an IOPS system, the method comprises the steps providing an IOPS MC application plane function, wherein:
an IOPS MC connectivity client supports a first reference point between the IOPS connectivity client and an IOPS connectivity function in the IOPS MC system, which first reference point is used for at least one of: user registration transactions and IOPS discovery procedures; and
an IOPS service client supports a second reference point between the IOPS MC service client and an IOPS packet distribution function in the IOPS MC system, which second reference point is used to carry IP packets in uplink and downlink between the IOPS MC service client and the IOPS packet distribution function based on unicast transmissions.

Another particular embodiment is directed to wireless device for enabling isolated operation for public safety (IOPS) mission critical (MC) operation in an IOPS system, the wireless device comprising processing circuitry configured to operatively provide an IOPS MC application plane function, wherein:
an IOPS MC connectivity client is configured to operatively support a first reference point between the IOPS connectivity client and an IOPS connectivity function in the IOPS MC system, which first reference point is used for at least one of: user registration transactions and IOPS discovery procedures; and
an IOPS service client is configured to operatively support a second reference point between the IOPS MC service client and an IOPS packet distribution function in the IOPS MC system, which second reference point is used to carry IP packets in uplink and downlink between the IOPS MC service client and the IOPS packet distribution function based on unicast transmissions.

Certain embodiments may provide one or more of the following technical advantage(s).
An application functional model does not require implementation of a full MC service server to support MC services during the IOPS mode of operation.
Coverage and capacity are considerably better when the communication is provided by an IOPS system supporting the proposed IOPS MC application functional model compared to an off-network communication utilizing ProSe.
Different options for establishing the communication between the MC UEs and the IOPS EPS system during the IOPS mode of operation.

### BREIF DESCRIPTION OF THE DRAWINGS

The proposed solutions are now described, by way of example, with reference to the accompanying drawings, in which:

FIG. 1 is a flowchart that illustrates an embodiment of the present solution;

FIG. 2 is a flowchart that illustrates another embodiment of the present solution;

FIG. 3 illustrates one example of a cellular communications system 300 in which embodiments of the present disclosure may be implemented;

FIG. 4 depicts a general IOPS MC functional model;

FIG. 5 a detailed IOPS MC functional model configured according to an embodiment of the present disclosure;

FIG. 6 defines the IOPS functional model for the signaling control plane configured according to an embodiment of the present disclosure to operate based on SIP signaling;

FIG. 7 defines the IOPS functional model for the application plane according to an embodiment of the present disclosure;

FIG. 8 is a schematic block diagram of a radio access node 800 according to some embodiments of the present disclosure;

FIG. 9 is a schematic block diagram that illustrates a virtualized embodiment of the radio access node 800 according to some embodiments of the present disclosure;

FIG. 10 is a schematic block diagram of the radio access node 800 according to some other embodiments of the present disclosure;

FIG. 11 is a schematic block diagram of a UE 1100 according to some embodiments of the present disclosure:

FIG. 12 is a schematic block diagram of the UE 1100 according to some other embodiments of the present disclosure.

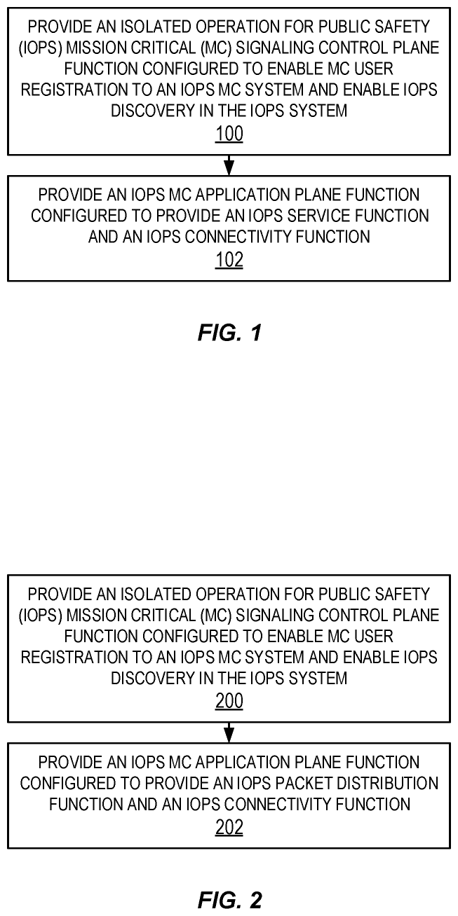

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Radio Node: As used herein, a “radio node” is either a radio access node or a wireless device.

Radio Access Node: As used herein, a “radio access node” or “radio network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network or any node that implements a core network function. Some examples of a core network node include, e.g., a Mobility Management Entity (MME), a Packet Data Network Gateway (PGW), a Service Capability Exposure Function (SCEF), a Home Subscriber Server (HSS), or the like. Some other examples of a core network node include a node implementing a Access and Mobility Function (AMF), a UPF, a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

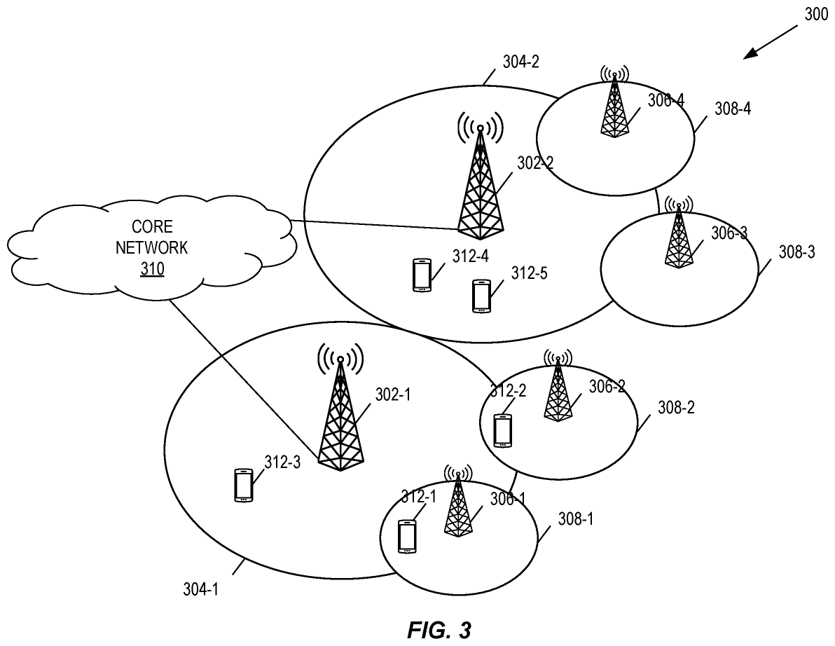

### FIG. 3

FIG. 3 illustrates one example of a cellular communications system 300 in which embodiments of the present disclosure may be implemented. In the embodiments described herein, the cellular communications system 300 may be configured to provide the IOPS EPS system. In this example, the RAN includes base stations 302-1 and 302-2, which in LTE are referred to as eNBs and in 5G NR are referred to as gNBs, may be configured for enabling isolated operation for the IOPS MC operation, controlling corresponding (macro) cells 304-1 and 304-2. The base stations 302-1 and 302-2 are generally referred to herein collectively as base stations 302 and individually as base station 302. Likewise, the (macro) cells 304-1 and 304-2 are generally referred to herein collectively as (macro) cells 304 and individually as (macro) cell 304. The RAN may also include a number of low power nodes 306-1 through 306-4 controlling corresponding small cells 308-1 through 308-4. The low power nodes 306-1 through 306-4 can be small base stations (such as pico or femto base stations) or Remote Radio Heads (RRHs), or the like. Notably, while not illustrated, one or more of the small cells 308-1 through 308-4 may alternatively be provided by the base stations 302. The low power nodes 306-1 through 306-4 are generally referred to herein collectively as low power nodes 306 and individually as low power node 306. Likewise, the small cells 308-1 through 308-4 are generally referred to herein collectively as small cells 308 and individually as small cell 308. The cellular communications system 300 also includes a core network 310, which in LTE is referred to as the Evolved Packet Core (EPC) and in the 5GS is referred to as the 5G core (5GC). The base stations 302 (and optionally the low power nodes 306) are connected to the core network 310.

The base stations 302 and the low power nodes 306 provide service to wireless devices 312-1 through 312-5 in the corresponding cells 304 and 308. The wireless devices 312-1 through 312-5 are generally referred to herein collectively as wireless devices 312 and individually as wireless device 312. The wireless devices 312 are also sometimes referred to herein as UEs.

In the embodiments described herein, at least some of the base stations 302 are IOPS-capable base stations (e.g., IOPS-capable eNBs), and at least some of the wireless devices 312 are MC service UEs.

Hereinafter, it is assumed that the public safety users (also referred to as MC service UEs or MC users or just UEs or users) have been provided with the configuration needed to utilize any MC service. Such a configuration, to be defined hereinafter as the MC service user configuration profile, is assumed to be stored at the UEs (e.g., stored by MC service clients operating on the UEs). For each UE, the MC service user configuration profile may include information (e.g., static data) needed for configuration of the MC service (e.g., MCPTT service) supported by the UE in question. The MC service user configuration profile stored in each UE may contain at least one of the following information: the current UE configuration, MC service user profile configuration, group configuration (e.g., group ID), and service configuration data or similar that is stored at the UE for off-network operation. Specific parameters about the off-network operate can be determined, for example, based on 3GPP TS 23.280 Annex A and 3GPP TS 23.379 Annex A for the MC services and MCPTT service UE/off-network, respectively. The MC service user configuration profile can be provisioned by offline procedures or after the UEs have been authenticated and registered with the central MC system.

In case there is a link failure between the radio access network (eNBs) (e.g., a particular base station 302) and the macro core network (e.g., the core network 310 which in this example is an EPC), the IOPS mode of operation may be initiated. Accordingly, the IOPS EPS system (e.g., IOPS-capable eNB(s) connected to a local EPC) may be configured to provide local connectivity to UEs that are in the coverage area of the IOPS EPS system. Note that the local EPC may be implemented within the IOPS-capable eNB or otherwise associated with (e.g., connected to) the IOPS-capable eNB.

To support MC services during the IOPS mode of operation, the IOPS mission critical (MC) functional model can be based on the off-network functional model as described in 3GPP TS 23.280, but the communication between the MC users may be established through the IOPS MC system instead of a ProSe direct communication. In this regard, a main function of the IOPS MC system may be to provide IP connectivity for enabling MC service communications among the MC users, as described in 3GPP TR 23.778 v16.0.0.

### IOPS Mission Critical Functional Model

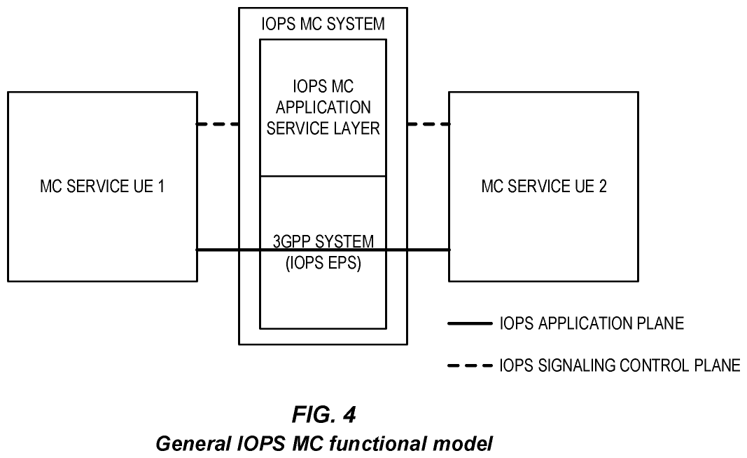

### FIG. 4

A general IOPS MC functional model is depicted in FIG. 4. As described above, the IOPS MC system's main function is to provide IP connectivity for the MC service communications among the MC users. To achieve that, the IOPS MC application service layer needs to enable discovery of the MC users who are served by the IOPS system and relay IP packets received from one MC user to another MC user(s) being served by the IOPS system, i.e. IP packets received in uplink from one MC user is relayed in downlink to another MC user(s) being served by the IOPS system..

As illustrated in FIG. 4, the IOPS MC functional model consists of an IOPS signaling control plane and an IOPS application plane. The IOPS signaling control plane is configured to provide the necessary signaling support for the registration of the MC users at the IOPS MC application service layer and for the IOPS discovery procedure. The IOPS application plane is configured to support the IOPS based IP connectivity communication, which includes required IOPS related application data as well as IP packets carrying off-network application related data to be relayed by the IOPS MC system. The off-network application related data may include all signaling control data and application data (control and media) generated during an off-network service communication among the MC users.

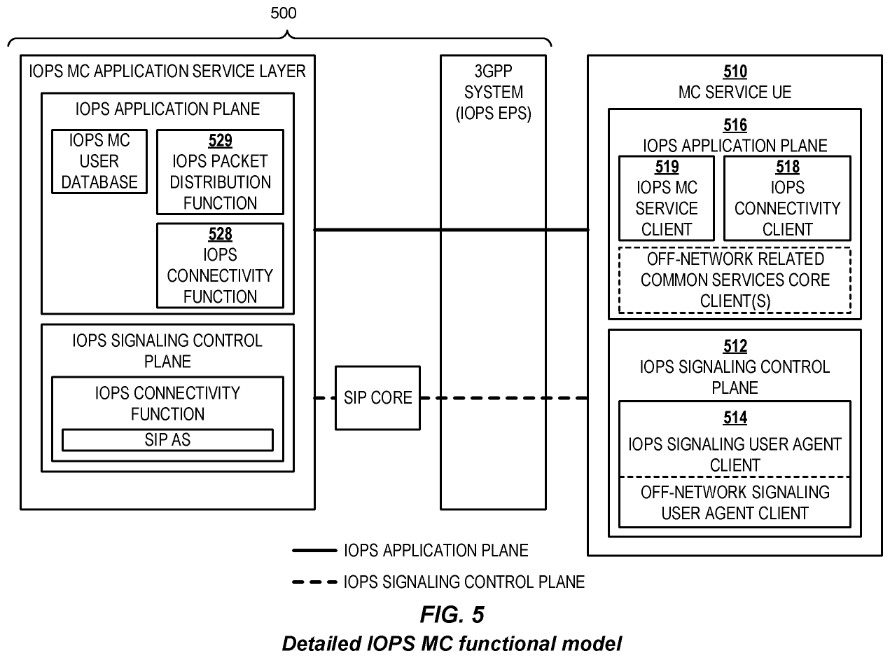

### FIG. 5

FIG. 5 provides a detailed IOPS MC functional model configured according to an embodiment of the present disclosure. At the IOPS MC application service layer of the IOPS MC system 500, the IOPS application plane is supported by an IOPS MC user database, an IOPS packet distribution function 529, and an lops connectivity function 528. The IOPS signaling control plane is supported by a Session Initiation Protocol (SIP) application server (AS) as part of the IPOS connectivity function.

In the MC service UE 510, the IOPS application plane is supported by an IOPS MC service client 519, an IOPS connectivity client 518, and the off-network related common service core client entities (as described in 3GPP TS 23.280). The IOPS signaling control plane is supported by an IOPS signaling user agent client 514, which also includes the functionalities of the off-network signaling user agent client (as described in 3GPP TS 23.280).

### IOPS Functional Model for the Signaling Control Plane

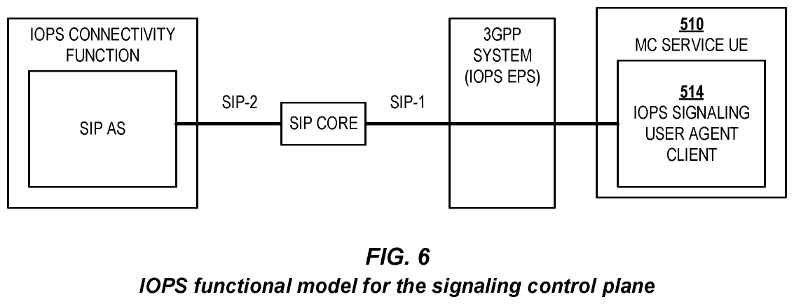

### FIG. 6

FIG. 6 defines the IOPS functional model for the signaling control plane configured according to an embodiment of the present disclosure to operate based on SIP signaling. In a non-limiting example, the SIP AS functionality in the IOPS connectivity function and the SIP user agent (not shown) in the IOPS signaling user agent client 514 are configured to support all SIP transactions, such as (SIP based) MC user registration to the IOPS MC system 500 and (SIP based)IOPS discovery related events (e.g., publish event, subscription event, and notification event). In addition, the IOPS signaling user agent client may be further configured to support all the functionalities required for the off-network signaling control plane as described in 3GPP TS 23.280.

The SIP core and the reference points SIP-1 and SIP-2 are described in 3GPP TS 23.280. The reference points SIP-1 and SIP-2 are required to support the IOPS related SIP transactions (e.g., SIP registration, authentication and security to the service layer, publish event, subscription event, and notification event).

### IOPS functional model for the application plane

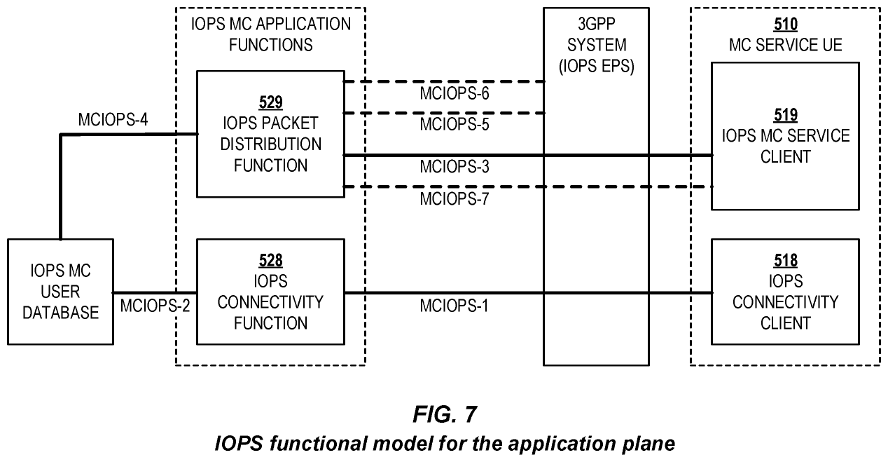

### FIG. 7

FIG. 7 defines the IOPS functional model for the application plane according to an embodiment of the present disclosure. The IOPS MC user database contains all IOPS related information managed by the IOPS connectivity function. In a non-limiting example, the IOPS related information includes, but not limited to, user registration related data and connectivity information data published by the MC users during the IOPS discovery procedure. The IOPS related information may be queried by the IOPS packet distribution function for the IOPS based IP connectivity communication.

The IOPS connectivity function 528 may be configured to provide support for, but not limited to, the user registration at the IOPS MC application service layer, the IOPS discovery procedure, and determining the registration status of an MC user on the IOPS MC system.

The IOPS packet distribution function 529 may be configured to mainly provide support for, but not limited to, the IOPS based IP connectivity communication, which may include handling and relaying IP packets containing the off-network application related data received in uplink from a MC UE 510. In this regard, the IOPS packet distribution function may operate based on the connectivity information available in the IOPS MC user database. With respect to handling IP packets, it may be necessary for the IPOS packet distribution function to de-capsulate the IP packets and/or determine the destination address (including group IP multicast addresses) of the IP packets to identify the targeted user(s). With respect to relaying IP packets, it may be necessary for the IPOS packet distribution function to replicate the IP packets to a group of users if the destination address of the IP packets corresponds to the group of users configured with unicast transmissions. In addition, the IPOS packet distribution function may be configured to support MBMS transmissions if enabled. The IOPS packet distribution function may be further configured to support network resource (bearer) management.

The IOPS MC service client 519 may be configured to support all MC service transactions, including the MC service client functionalities as described in 3GPP TS 23.280 and the corresponding MC service TS (i.e. 3GPP TS 23.379, 23.281, 23.282). The IOPS MC service client may also be configured to support the IOPS related transactions, for example, supporting the IOPS based IP connectivity communication. In this regard, the IPOS MC service client may encapsulate off-network application related data (signaling control data and application data) into the IP packets to be transmitted in uplink to the IOPS MC system, which relays the IP packets in downlink to one or more other MC user(s). In particular, the IOPS MC service client 519 may support a reference point (MCIOPS-3) between the IOPS service client and an IOPS packet distribution function at the IOPS MC application service layer of the IOPS MC system.

The IOPS connectivity client 518 may be configured to support the user registration in the IOPS MC application service layer and the IOPS discovery procedure. In a non-limiting example, the IOPS connectivity client can be integrated into the IOPS MC service client. In particular, the IOPS connectivity client 518 may support a reference point (MCIOPS-1) between the IOPS MC connectivity client and an IOPS connectivity function at the IOPS MC application service layer of the IOPS MC system.

### MCIOPS-1

The reference point MCIOPS-1 exists between the IOPS connectivity client and the IOPS connectivity function in the IOPS MC system 500. The MCIOPS-1 reference point may be used for the user registration and other required transactions (e.g., publish events, subscription events, and notification events). The MCIOPS-1 reference point may use SIP-1 and SIP-2 reference points (not shown) for transporting and routing of SIP signaling.

### MCIOPS-2

The MCIOPS-2 reference point exists between the IOPS connectivity function and the IOPS MC user database. The MCIOPS-2 reference point may be used by the IOPS connectivity function to manage the connectivity information obtained from the MC users. The MCIOPS -2 reference point may utilize a diameter management application protocol (e.g., as defined in 3GPP TS 29.283 v15.0.0). Notably, other protocols could also be utilized herein.

### MCIOPS-3

The MCIOPS-3 reference point exists between the IOPS MC service client and the IOPS packet distribution function in the IOPS MC system 500. The MCIOPS-3 reference point may be used to relay (i.e. carry) IP packets between the IOPS packet distribution function and the IOPS MC service client(s) based on unicast transmissions, i.e. relay IP packets from one MC user to one or more other MC users. In other words, relay IP packets in downlink and uplink between the IOPS packet distribution function and the IOPS MC service client(s) being served by the IOPS system. The MCIOPS-3 reference point may use the SGi reference point (not shown) as defined in 3GPP TS 23.002 v15.0.0.

### MCIOPS-4

The MCIOPS-4 reference point exists between the IOPS packet distribution function and the IOPS MC user database. The MCIOPS-4 reference point may be used by the IOPS packet distribution function to obtain user connectivity information for handling and relaying the IOPS related IP packets. The MCIOPS-4 reference point may utilize a diameter management application protocol (e.g., as defined in 3GPP TS 29.283 v15.0.0). Other protocol may be utilized as well.

### MCIOPS-5

The MCIOPS-5 reference point exists between the IOPS packet distribution function and the 3GPP system (i.e. the IOPS EPS). The MCIOPS-5 reference point may be used, subject to the conditions described below, by the IOPS packet distribution function to obtain unicast bearers with appropriate QoS from the IOPS EPS. The MCIOPS-5 reference point may utilize the Rx interface of the EPS according to 3GPP TS 23.203 v15.0.0.

The MCIOPS-5 reference point will not be used if the MC users are configured by the IOPS EPS with a default unicast bearer. The MCIOPS-5 reference point will also not be used if an IOPS service provider and the PLMN operator do not have an operational agreement for QoS control to be provided directly from the IOPS MC application service provider domain.

### MCIOPS-6

The MCIOPS-6 reference point exists between the IOPS packet distribution function and the 3GPP system (e.g., the IOPS EPS). The MCIOPS-6 reference point may be used if multicast transmissions are enabled to support MC services during the IOPS mode of operation. The MCIOPS-6 reference point may be used to request allocation and activation of multicast transport resources for the MC services during the IOPS mode of operation. The MCIOPS-6 reference point may use the MB2-C interface as defined in 3GPP TS 29.468 v15.6.0.

### MCIOPS-7

The MCIOPS-7 reference point exists between the IOPS packet distribution function and the 3GPP system (e.g., the IOPS EPS). The MCIOPS-7 reference point may be used if multicast transmissions are enabled to support MC services during the IOPS mode of operation. The MCIOPS-7 reference point may be used by the IOPS packet distribution function to relay IP packets based on multicast transmissions to the IOPS MC service client(s). The MCIOPS -7 reference point uses the MB2-U interface defined in 3GPP TS 23.468 v15.6.0.

### Network Resource Management for the IOPS Mode of Operation

In a normal on-network operation, an EPS system can configure the MC UEs with network resources (e.g., EPS bearers) for MC service communications as described in 3GPP TS 23.280 and the corresponding MC service TS (i.e. 3GPP TS 23.379, 23.281, 23.282). The EPS bearers may be unicast bearers or multicast bearers.

In the IOPS mode of operation, as described in 3GPP TS 23.401 Annex K, the IOPS EPS may provide local connectivity to the public safety users (MC UEs) who are within the communication range of the system. In one embodiment, the MC UEs may utilize one or more specific access point names (APNs) in the IOPS mode of operation. For example, the MC UEs may utilize one IOPS APN for the related SIP transactions (e.g., via the MCIOPS-1 reference point) and another IOPS APN to relay MC service related IP packets via the IOPS MC system (e.g., over the MCIOPS-3 and MCIOPS-7 reference points). In a non-limiting example, IOPS related SIP signaling transactions can be enabled as defined in 3GPP TS 23.280.

In another embodiment, the IOPS EPS may directly configure an MC UE using a pre-defined IOPS bearer with specific characteristics when the IOPS APN is utilized by the MC UE to transmit the MC services related IP packets via the IOPS MC system. The pre-defined IOPS bearer can be a default unicast bearer determined based on quality of service (QoS) class identifier (QCI) characteristics as specified in 3GPP TS 23.203 v16.0.0. For example, the IOPS bearer can be configured with the characteristics of QCI 65, which is specified for the MCPTT service in normal on-network operation. This implies, unlike a normal operation, that a request of resources over the MCIOPS-5 reference point, i.e. the Rx interface, is not needed for the configuration of network resources. In another embodiment, the IOPS EPS may configure one or more public safety users using one or more IOPS bearers (e.g., the default unicast EPS bearers and/or dedicated unicast EPS bearers) and request network resources (e.g., activation of dedicated unicast EPS bearers or multicast EPS bearers) for the one or more public safety users.

In another embodiment, a MC UE may utilize different IOPS MC service APNs based on what type of MC service related IP packets the MC UE intends to transmit over the IOPS MC system. For example, the MC UE can utilize a specific IOPS APN when the IP packets to be transmitted to the IOPS packet distribution function are MCPTT service related (e.g., an IOPS MCPTT APN). In this regard, based on the IOPS MCPTT APN, the IOPS EPS may directly configure the MC UE with specific IOPS unicast bearers, such as a default bearer (e.g., QCI 6), a dedicated bearer (e.g., QCI 65) for the IP packets carrying the off-network application related data, and another dedicated bearer (e.g., QCI 69) for the IOPS signaling. Likewise, the same IOPS bearer configuration may be utilized for MCVideo and MCData services with the respective QCIs. This implies, unlike a normal operation, that a request of resources (e.g., the activation of dedicated unicast bearers) over the MCIOPS-5 reference point (e.g., the Rx interface) is not needed for the configuration of network resources.

In another embodiment, the configuration of network resources may also be based on the normal on-network operation. For example, a request of resources is sent from the IOPS packet distribution function over the Rx interface (MCIOPS-5 reference point) can include an application identifier for the MC service such that the PCRF can determine the correct QCI.

In another embodiment, MBMS bearers can also be configured for the IOPS mode of operation in a combination with the above described options considering unicast IOPS bearers. In this regard, the MCIOPS-6 and MCIOPS-7 reference points are used.

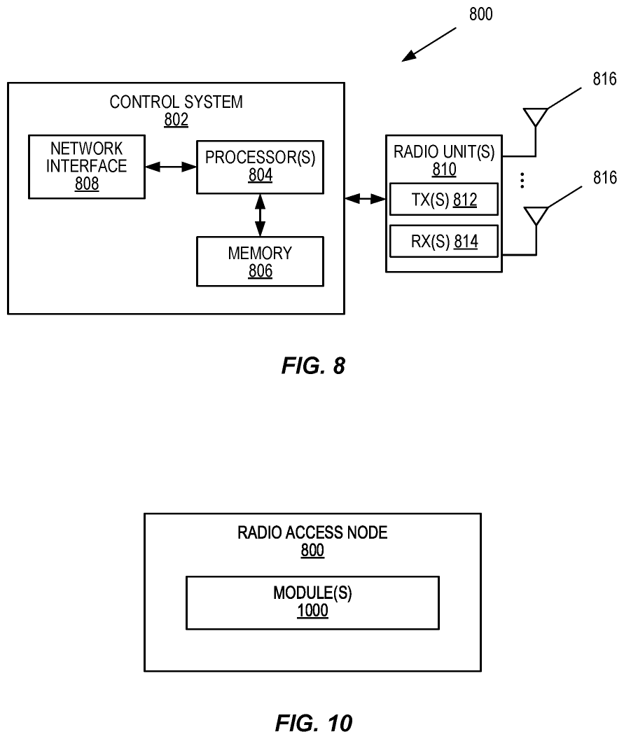

### FIG. 8

FIG. 8 is a schematic block diagram of a radio access node 800 according to some embodiments of the present disclosure. The radio access node 800 may be, for example, a base station 302 or 306. As illustrated, the radio access node 800 includes a control system 802 that includes one or more processors 804 (e.g., Central Processing Units (CPUs), Application Specific Integrated Circuits (ASICs), Field Programmable Gate Arrays (FPGAs), and/or the like), memory 806, and a network interface 808. The one or more processors 804 are also referred to herein as processing circuitry. In addition, the radio access node 800 includes one or more radio units 810 that each includes one or more transmitters 812 and one or more receivers 814 coupled to one or more antennas 816. The radio units 810 may be referred to or be part of radio interface circuitry. In some embodiments, the radio unit(s) 810 is external to the control system 802 and connected to the control system 802 via, e.g., a wired connection (e.g., an optical cable). However, in some other embodiments, the radio unit(s) 810 and potentially the antenna(s) 816 are integrated together with the control system 802. The one or more processors 804 operate to provide one or more functions of a radio access node 800 as described herein. In some embodiments, the function(s) are implemented in software that is stored, e.g., in the memory 806 and executed by the one or more processors 804.

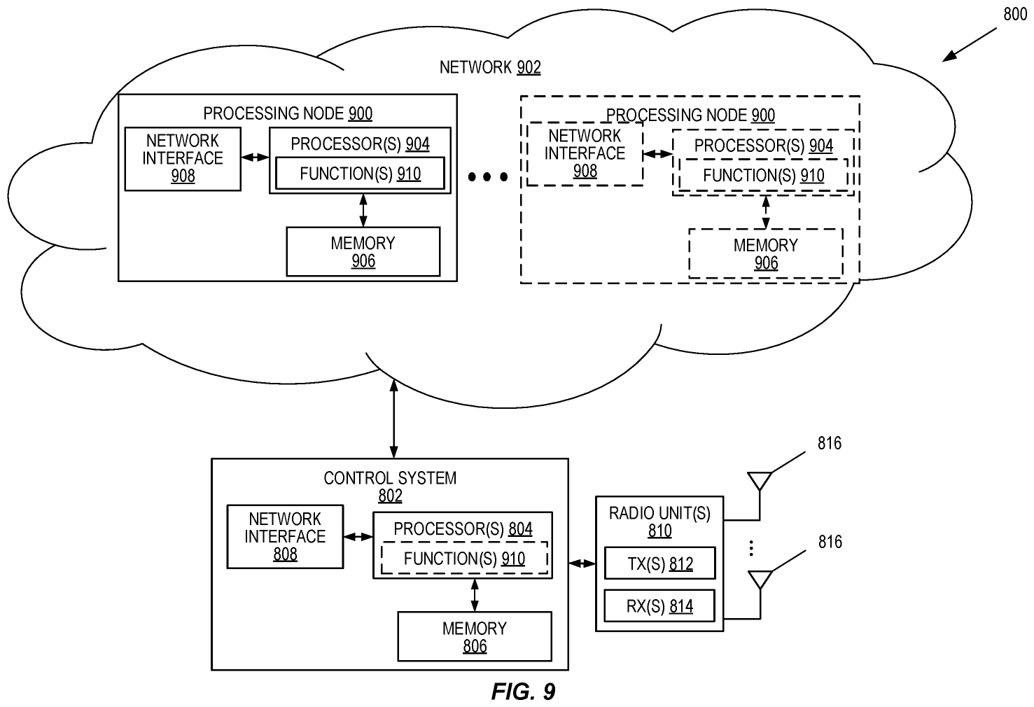

### FIG. 9

FIG. 9 is a schematic block diagram that illustrates a virtualized embodiment of the radio access node 800 according to some embodiments of the present disclosure. This discussion is equally applicable to other types of network nodes. Further, other types of network nodes may have similar virtualized architectures.

As used herein, a “virtualized” radio access node is an implementation of the radio access node 800 in which at least a portion of the functionality of the radio access node 800 is implemented as a virtual component(s) (e.g., via a virtual machine(s) executing on a physical processing node(s) in a network(s)). As illustrated, in this example, the radio access node 800 includes the control system 802 that includes the one or more processors 804 (e.g., CPUs, ASICs, FPGAs, and/or the like), the memory 806, and the network interface 808 and the one or more radio units 810 that each includes the one or more transmitters 812 and the one or more receivers 814 coupled to the one or more antennas 816, as described above. The control system 802 is connected to the radio unit(s) 810 via, for example, an optical cable or the like. The control system 802 is connected to one or more processing nodes 900 coupled to or included as part of a network(s) 902 via the network interface 808. Each processing node 900 includes one or more processors 904 (e.g., CPUs, ASICs, FPGAs, and/or the like), memory 906, and a network interface 908.

In this example, functions 910 of the radio access node 800 described herein are implemented at the one or more processing nodes 900 or distributed across the control system 802 and the one or more processing nodes 900 in any desired manner. In some particular embodiments, some or all of the functions 910 of the radio access node 800 described herein are implemented as virtual components executed by one or more virtual machines implemented in a virtual environment(s) hosted by the processing node(s) 900. As will be appreciated by one of ordinary skill in the art, additional signaling or communication between the processing node(s) 900 and the control system 802 is used in order to carry out at least some of the desired functions 910. Notably, in some embodiments, the control system 802 may not be included, in which case the radio unit(s) 810 communicate directly with the processing node(s) 900 via an appropriate network interface(s).

In some embodiments, a computer program including instructions which, when executed by at least one processor, causes the at least one processor to carry out the functionality of radio access node 800 or a node (e.g., a processing node 900) implementing one or more of the functions 910 of the radio access node 800 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

### FIG. 10

FIG. 10 is a schematic block diagram of the radio access node 800 according to some other embodiments of the present disclosure. The radio access node 800 includes one or more modules 1000, each of which is implemented in software. The module(s) 1000 provide the functionality of the radio access node 800 described herein. This discussion is equally applicable to the processing node 900 of FIG. 9 where the modules 1000 may be implemented at one of the processing nodes 900 or distributed across multiple processing nodes 900 and/or distributed across the processing node(s) 900 and the control system 802.

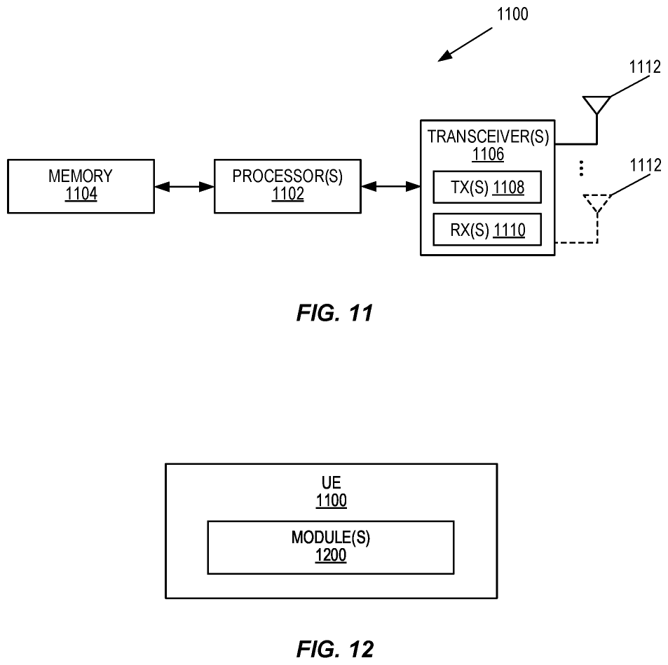

### FIG. 11

FIG. 11 is a schematic block diagram of a UE 1100 according to some embodiments of the present disclosure. As illustrated, the UE 1100 includes one or more processors 1102 (e.g., CPUs, ASICs, FPGAs, and/or the like), memory 1104, and one or more transceivers 1106 each including one or more transmitters 1108 and one or more receivers 1110 coupled to one or more antennas 1112. The transceiver(s) 1106 includes radio-front end circuitry connected to the antenna(s) 1112 that is configured to condition signals communicated between the antenna(s) 1112 and the processor(s) 1102, as will be appreciated by on of ordinary skill in the art. The processors 1102 are also referred to herein as processing circuitry. The transceivers 1106 are also referred to herein as radio circuitry. In some embodiments, the functionality of the UE 1100 described above may be fully or partially implemented in software that is, e.g., stored in the memory 1104 and executed by the processor(s) 1102. Note that the UE 1100 may include additional components not illustrated in FIG. 11 such as, e.g., one or more user interface components (e.g., an input/output interface including a display, buttons, a touch screen, a microphone, a speaker(s), and/or the like and/or any other components for allowing input of information into the UE 1100 and/or allowing output of information from the UE 1100), a power supply (e.g., a battery and associated power circuitry), etc.

In some embodiments, a computer program including instructions which, when executed by at least one processor, causes the at least one processor to carry out the functionality of the UE 1100 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

### FIG. 12

FIG. 12 is a schematic block diagram of the UE 1100 according to some other embodiments of the present disclosure. The UE 1100 includes one or more modules 1200, each of which is implemented in software. The module(s) 1200 provide the functionality of the UE 1100 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some of the embodiments described above may be summarized in the following manner:

### Group A Embodiments

1. A method performed by a wireless device for enabling isolated operation for public safety (IOPS) mission critical (MC) operation, the method comprising at least one of the following steps:

providing (100) an IOPS MC signaling control plane function configured to:
enable MC user registration to an IOPS MC system; and
enable IOPS discovery in the IOPS MC system; and

providing (102) an IOPS MC application plane function configured to provide an IPOS service function and an IOPS connectivity function.
2. The method of embodiment 1, further comprising the step of providing the IOPS MC signaling control plane function via Session Initiation Protocol (SIP)-based signaling.
3. The method of embodiment 2, wherein the SIP-based signaling comprises SIP-based MC user registration and SIP-based IOPS discovery.
4. The method of embodiment 1, wherein the IOPS MC signaling control plane function is further configured to enable 3GPP off-network signaling control plane.
5. The method of embodiment 1, wherein the IOPS service function is configured to:

enable IOPS Internet Protocol (IP) connectivity communication in the IOPS MC system; and

encapsulate off-network application related data in to IP packets for communication via the IOPS

MC system.
6. The method of embodiment 5, wherein the IOPS service function is configured to enable one or more MC service client functionalities as defined in 3GPP TS 23.280, 3GPP TS 23.379, 3GPP TS 23.281, and/or 3GPP TS 23.282.
7. The method of embodiment 1, wherein the IOPS connectivity function is configured to:

support user registration in an IOPS MC application service layer; and

enable IOPS discovery procedure.
8. The method of any of the previous embodiments, further comprising integrating the IOPS connectivity function with the IOPS service function.

### Group B Embodiments

9. A method performed by a node coupled to an isolated operation for public safety (IOPS) evolved packet system (EPS) for implementing IOPS mission critical (MC) application service, the method comprising at least one of the following steps:

providing (200) an IOPS MC signaling control plane function configured to:
enable MC user registration to an IOPS MC system; and
enable IOPS discovery in the IOPS MC system; and

providing (202) an IOPS MC application plane function configured to provide an IPOS packet distribution function and an IOPS connectivity function.
10. The method of embodiment 9, further comprising the step of providing the IOPS MC signaling control plane function via Session Initiation Protocol (SIP)-based signaling.
11. The method of embodiment 10, wherein the SIP-based signaling comprises SIP-based MC user registration and SIP-based IOPS discovery.
12. The method of embodiment 9, wherein the IOPS MC application plane function is further configured to:

store IPOS related user information into an IOPS MC user database; and

retrieve the IOPS related user information from the IOPS MC user database.
13. The method of embodiment 12, wherein the IOPS packet distribution function is configured to support IOPS based Internet Protocol (IP) connectivity communication in the IOPS MC system.
14. The method of embodiment 13, further comprising handling and relaying one or more IP packets comprising off-network application data received from an MC UE based on connectivity information available in the IOPS MC user database.
15. The method of embodiment 14, further comprising:

de-capsulating the one or more IP packets to determine a destination address (e.g., including group IP multicast addresses) of the one or more IP packets; and

replicating the one or more IP packets to a group of users when the destination address corresponds to the group of users.
16. The method of embodiment 9, further comprising providing network resources (e.g. EPS bearers) for enabling MC service communications in the IOPS mode of operation.
17. The method of embodiment 16, further comprising providing local connectivity to one or more the public safety users (e.g., MC UEs) located within communication range of the base station in the IOPS mode of operation.
18. The method of embodiment 17, further comprising communicating with the one or more public safety users using one or more specific access point names (APNs) in the IOPS mode of operation.
19. The method of embodiment 18, further comprising utilizing different IOPS MC service specific access point names (APNs) based on different type of MC service related packets.
20. The method of embodiment 19, further comprising configuring the one or more public safety users using a pre-defined IOPS bearer (e.g., a default unicast EPS bearer) with specific characteristics (e.g., QoS/QCI characteristics as specified in 3GPP TS 23.203 v16.0.0) when the one or more APNs are utilized by the one or more public safety users to transmit MC service related IP packets.
21. The method of embodiment 20, further comprising configuring the one or more public safety users using one or more IOPS bearers (e.g., default unicast EPS bearers and/or dedicated unicast EPS bearers).
22. The method of embodiment 19, further comprising requesting network resources (e.g., activation of dedicated unicast EPS bearers or multicast EPS bearers) for the one or more public safety users.

### Group C Embodiments

23. A wireless device for enabling isolated operation for public safety (IOPS) mission critical (MC) operation, the wireless device comprising:

processing circuitry configured to perform any of the steps of any of the Group A embodiments; and

power supply circuitry configured to supply power to the wireless device.
24. A base station for enabling isolated operation for public safety (IOPS) mission critical (MC) operation, the base station comprising:

processing circuitry configured to perform any of the steps of any of the Group B embodiments; and

power supply circuitry configured to supply power to the base station.
25. A User Equipment, UE, for enabling isolated operation for public safety (IOPS) mission critical (MC) operation, the UE comprising:

an antenna configured to send and receive wireless signals;

radio front-end circuitry connected to the antenna and to processing circuitry, and configured to condition signals communicated between the antenna and the processing circuitry;

the processing circuitry being configured to perform any of the steps of any of the Group A embodiments;

an input interface connected to the processing circuitry and configured to allow input of information into the UE to be processed by the processing circuitry;

an output interface connected to the processing circuitry and configured to output information from the UE that has been processed by the processing circuitry; and

a battery connected to the processing circuitry and configured to supply power to the UE.

Some other embodiments described above may be summarized in the following manner:
1. A method performed by a wireless device 312, 510 for enabling isolated operation for public safety (IOPS) mission critical (MC) operation in an IOPS system 500, the method comprising the steps of providing 102 an IOPS MC application plane function 516, wherein:

an IOPS MC connectivity client 518 supports a first reference point MCIOPS-1 between the IOPS connectivity client and an IOPS connectivity function 528 in the IOPS MC system, which first reference point is used for at least one of: user registration transactions and IOPS discovery procedures; and

an IOPS service client 519 supports a second reference point MCIOPS-3 between the IOPS MC service client and an IOPS packet distribution function 529 in the IOPS MC system, which second reference point is used to carry IP packets in uplink and downlink between the IOPS MC service client and the IOPS packet distribution function based on unicast transmissions.
2. A wireless device 312, 510 for enabling isolated operation for public safety (IOPS) mission critical (MC) operation in an IOPS system 500, the wireless device comprising processing circuitry configured to operatively provide 102 an IOPS MC application plane function 516, wherein:

an IOPS MC connectivity client 518 is configured to operatively support a first reference point (MCIOPS-1) between the IOPS connectivity client and an IOPS connectivity function 528 in the IOPS MC system, which first reference point is used for at least one of: user registration transactions and IOPS discovery procedures; and

an IOPS service client 519 is configured to operatively support a second reference point (MCIOPS-3) between the IOPS MC service client and an IOPS packet distribution function 529 in the IOPS MC system, which second reference point is used to carry IP packets in uplink and downlink between the IOPS MC service client and the IOPS packet distribution function based on unicast transmissions.

### Abbreviations

At least some of the following abbreviations may be used in this disclosure. If there is an inconsistency between abbreviations, preference should be given to how it is used above. If listed multiple times below, the first listing should be preferred over any subsequent listing(s).
3G Third Generation
3GPP Third Generation Partnership Project
4G Fourth Generation
5G Fifth Generation
AF Application Function
AMF Access and Mobility Management Function
AN Access Network
AP Access Point
AUSF Authentication Server Function
BCCH Broadcast Control Channel
BCH Broadcast Channel
BS Base Station
BSC Base Station Controller
BTS Base Transceiver Station
CDMA Code Division Multiple Access
CGI Cell Global Identifier
CIR Channel Impulse Response
CSI Channel State Information
DCCH Dedicated Control Channel
DL Downlink
DN Data Network
DRX Discontinuous Reception
DTX Discontinuous Transmission
ECGI Evolved Cell Global Identifier
eNB Enhanced or Evolved Node B
EPC Evolved Packet Core
EPS Evolved Packet System
E-UTRA Evolved Universal Terrestrial Radio Access
E-UTRAN Evolved Universal Terrestrial Radio Access Network
GC Group Communication
GERAN Global System for Mobile (GSM) Communications Enhanced Data Rates for
GSM Evolution Radio Access Network
gNB New Radio Base Station
GSM Global System for Mobile Communications
HO Handover
HSPA High Speed Packet Access
IOPS Isolated Evolved Universal Terrestrial Radio Access Network Operations for
Public Safety
IoT Internet of Things
IP Internet Protocol
LAN Local Area Network
LTE Long Term Evolution
M2M Machine-to-Machine
MAC Medium Access Control
MBMS Multimedia Broadcast Multicast Services
MBSFN Multimedia Broadcast Multicast Service Single Frequency Network
MC Mission Critical
MCE Multi-Cell/Multicast Coordination Entity
MIB Master Information Block
MME Mobility Management Entity
MSC Mobile Switching Center
MTC Machine Type Communication
NEF Network Exposure Function
NF Network Function
NFV Network Function Virtualization
NR New Radio
NRF Network Function Repository Function
NSSF Network Slice Selection Function
O&M Operation and Maintenance
OFDM Orthogonal Frequency Division Multiplexing
OFDMAOrthogonal Frequency Division Multiple Access
OSS Operations Support System
PCF Policy Control Function
P-GW Packet Data Network Gateway
PLMN Public Land Mobile Network
PRB Physical Resource Block
ProSe Proximity Services
PSTN Public Switched Telephone Networks
PTT Push to Talk
QoS Quality of Service
RAN Radio Access Network
RAT Radio Access Technology
RNC Radio Network Controller
SCEF Service Capability Exposure Function
S-GW Serving Gateway
SIB System Information Block
SIM Subscriber Identity Module
SMF Session Management Function
TCP Transmission Control Protocol
TDD Time Division Duplexing
UDM Unified Data Management
UE User Equipment
UL Uplink
UMTS Universal Mobile Telecommunications System
USIM Universal Subscriber Identity Module
UTRA Universal Terrestrial Radio Access
UTRAN Universal Terrestrial Radio Access Network
VolP Voice over Internet Protocol
WAN Wide Area Network
WCDMA Wideband Code Division Multiple Access
WD Wireless Device
WLAN Wireless Local Area Network

1. A method performed by a wireless device for enabling isolated operation for public safety, IOPS, mission critical, MC, operation in an IOPS system, the method comprising the steps of providing an IOPS MC application plane function, wherein:
an IOPS MC connectivity client supports a first reference point between the IOPS connectivity client and an IOPS connectivity function in the IOPS MC system, which first reference point is used for at least one of: user registration transactions and IOPS discovery procedures; and
an IOPS service client supports a second reference point between the IOPS MC service client and an IOPS packet distribution function in the IOPS MC system, which second reference point is used to carry IP packets in uplink and downlink between the IOPS MC service client and the IOPS packet distribution function based on unicast transmissions.

2. A wireless device for enabling isolated operation for public safety, IOPS, mission critical, MC, operation in an IOPS system, the wireless device comprising processing circuitry configured to operatively provide an IOPS MC application plane function, wherein:
an IOPS MC connectivity client is configured to operatively support a first reference point between the IOPS connectivity client and an IOPS connectivity function in the IOPS MC system, which first reference point is used for at least one of: user registration transactions and IOPS discovery procedures; and
an IOPS service client is configured to operatively support a second reference point between the IOPS MC service client and an IOPS packet distribution function in the IOPS MC system, which second reference point is used to carry IP packets in uplink and downlink between the IOPS MC service client and the IOPS packet distribution function based on unicast transmissions.
